(19) United States
(12) Patent Application Publication
(10) Pub. No.: US 2003/0163459 A1
(43) Pub. Date: Aug. 28, 2003

(54) Method and a system for creating a dynamic newspaper

(76) Inventor: Jonathan Shem-Ur, Tel-Aviv (IL)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/296,700

(22) PCT Filed: May 30, 2001
(86) PCT No.: PCT/IL01/00499

(30) Foreign Application Priority Data
May 31, 2000 (IL) 136481

(51) Int. Cl. G06F 7/00

(52) U.S. Cl. 707/3

(57) ABSTRACT

A method for obtaining at least one dynamic internet web site newspaper comprising: (a) selecting a suitable newspaper category that matches the subject of the article to be typed and inserted to the newspaper; (b) gathering the typed articles by the users into the appropriate selected newspaper in a prearranged newspaper format; (c) automatically calculating the number of people reading each article and accordingly continuously upgrading the location of each article in the newspaper according to the number of hits to the article page. A system for creating, transmitting, receiving and processing information for displaying a dynamic newspaper using the method is also disclosed.

### FIELD OF INVENTION

The present invention relates to a method for creating a dynamic newspaper. More specifically the present invention relates to a method for creating, transmitting, receiving and processing a dynamic internet web site newspaper. Furthermore, the present invention relates to a system for creating a dynamic newspaper using the said method.

In the context of the present invention the term “dynamic newspaper” relates to a newspaper in which the articles are continuously updated by the user computers and readers according to the number of hits to the article page. In the context of the present invention the tem “article” means an article including any opinion, information question or any other written text in any subject.

The method and system provided by the present invention are especially useful for enhancing the functionality of the Web by providing users from all over the world with an easy web-based access to thousands of classified dynamic newspapers, each relating to special field of interest.

The method and system of the present invention provides the possibility for high-variety newspapers in different specifications that are being continuously non-stop clanging, eider by the content of articles that have been typed by the users or by the arrangement of the articles to new location, according to the hit's number.

### BACKGROUND OF THE INVENTION

Recently, and more particularly in the last two years, growth in the use of the Internet has been explosive. Much of the recent growth is attributable to the popularity of the World Wide Web (WWW). The World Wide Web (Web) is a network of information resources. In other words, the Web is the collection of all browsers, servers, files, and browser-accessible services through the Internet.

In order to publish a document in the web, it must be made available to a Web server. Web servers retrieve Web documents in response to browser requests and forward the documents to the requesting browsers via the Internet. Web servers also provide gateways that enable browsers to access Web-related applications, such as database searches an electronic payment systems, as well as other internet services, such as Gopher and Wide Area Information Search (WAIS).

Because the Web uses the Internet as its communication medium, it must follow the Internet communication protocols. A protocol is a set of rules governing the procedure for exchanging information. The Internet's Transmission Control Protocol (TCP) and Internet Protocol (IF) enable worldwide connectivity between browsers and servers. In addition to using the TCP/IP protocols for communication across the Internet, the Web also uses its own protocol, called the Hypertext Transfer Protocol (HTTP), for exchange between browsers and servers Browsers to request documents from servers and by servers to return requested documents to browsers use HTTP.

Significant progress in communication has occurred in modem society due the increasing popularity and accessibility of the Internet. Through this ever-growing network of computers, people are able to transmit messages, share information, discuss topics, and communicate in a wider variety of ways that was ever before possible.

In the Internet world today, the most popular means, for transmitting and receiving any piece of information are by Email, Chat, FAQ (Frequently Asked Questions) and Search Engines.

Today, there are many disadvantages related to the conventional ordinary newspapers, (even if they appear in the internet), since their articles are steady and unchangeable after the time of publication. The news, information and articles in said traditional newspapers cannot be replaced in the sane day, or week or month if it was a daily, weekly or monthly issue, respectively. Furthermore, the editors do not have always the fall information, since they solely depend on the reporters.

Surprisingly, the present invention method and system, overcomes these abovementioned disadvantages. The users and the readers in the present invention are both the editors and the providers of the news and the information for the newspaper, so there may be thousands of “dynamic newspapers” that being edited in many specific topics.

To take advantage the above modem dynamic newspaper, it is a main object of the present invention to provide a method to create a dynamic newspaper having articles written by the internet users and automatically and continuously edited and upgraded by the readers according to the number of hits.

It is also an object of the present invention is to provide a system to create, transmit, receive and process information in a dynamic newspaper. It is another object of the present invention to provide a new dynamic newspaper providing dimension for search and find topic, unlike he traditional newspapers.

### SUMMARY OF INVENTION

The present invention relates to a method and a system for accessing and maintaining a plurality of dynamic newspapers which axe an internet site containing information that are continuously updated and managed from a user location;

The present invention also relates to a new and useful method for gathering and rating the information in a daily master edition dynamic newspaper according to the number of the reader's entrance to every article in a plurality specified dynamic newspaper;

An important feature and advantage of this invention is that any one, even if he is not skilled ma the art, can use the system, and therefore, it is a friendly and easy interface.

More specifically, in addition to the above-described method, the present invention relates to a method for obtaining at least one dynamic internet web site newspaper which comprising:

(a) selecting a suitable newspaper category that matches the subject of the article to be typed and inserted to the newspaper;

(b) gathering the typed articles by the users into the appropriate selected newspaper in a prearranged newspaper format; and

(c) automatically calculating the number of people reading each article page and accordingly continuously upgrading the location of each article in the newspaper according to the number of hits to the article page.

The articles in the said dynamic newspaper can be deleted after predetermined period of time. Articles in the said dynamic newspaper can be deleted also if not read for a predetermined period of time. The method of the present invention can optionally have further steps, comprising:

(d) creating a category of general master, not specified, dynamic newspaper and;

(e) collecting the most widely read articles in all the specific newspapers and rating of them in the appropriating location of the general master edition.

The present invention further relates to a system for creating, transmitting, receiving and processing information for displaying a dynamic newspaper using the method as defined in any of the preceding claims comprising:

(a) a Web server computer that hosting the web site and its applications software and linked to the Internet Network and provide a gateways that enables browsers to access the Web-related applications;

(b) an application software, which is a computer software program receiving, and processing the classified articles and sorting them to tie appropriate dynamic newspaper;

(c) a browser, computer program element, is the user's window interface to the Web, providing the capability to view Web documents and access Web-based services and applications;

The present invention also relates to a dynamic internet web site newspaper characterized by continuing editing and upgrading the articles according to the number of hits to the article page;

The present invention further relates to a general master dynamic newspaper having the most widely read articles in a defined group of specific dynamic newspapers and rating the said articles in the appropriate location according to the number of hits in the specific dynamic newspaper.

### BRIEF DESCRIPTION OF THE DRAWINGS

The present invention will be more fully appreciated by consideration of the following detailed description, when read in light of the accompanying drawing in which:

FIG. 1 illustrates a communications network diagram of the invention;

FIG. 2 illustrates the web pages diagram of the web site of the invention;

### DETAILED DESCRIPTION OF THE DRAWINGS

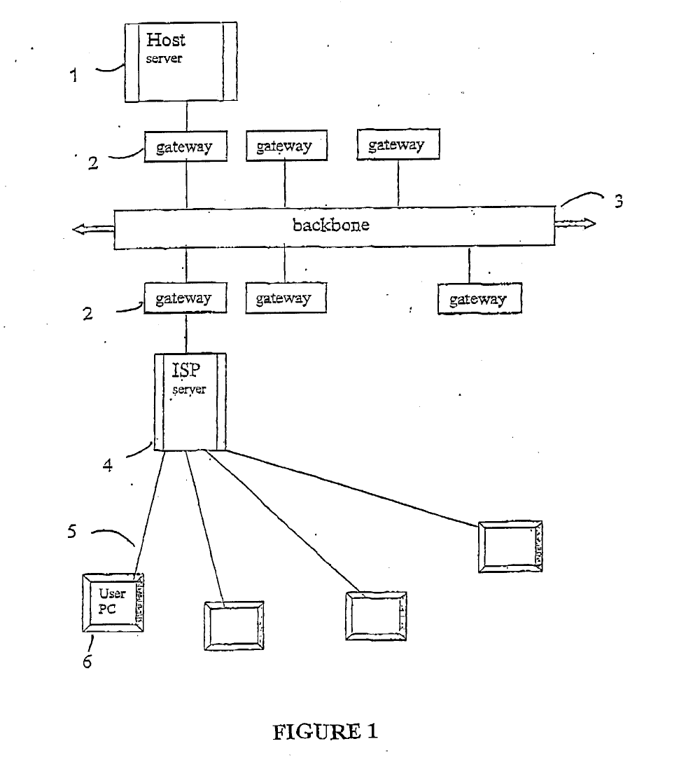

FIG. 1 illustrates a communication network diagram of tile system. The system includes a host server computer (1) connected to the backbone (3) via gateway (2), which are comprising the network line.

The ISP (Internet Service Provider) server computer (4) is led to the backbone (3) via the gateways (2) too. Plurality users PC (6) are connected to the ISP server (4) through cables or telephone lines (5). In a preferred embodiment of the present invention, the host server computer (1) is part of the computer network referred to as the Internet, and can access a portion of the Internet known as the World Wide Web (“Web”). As is well known, the Web includes a plurality of Web sites.

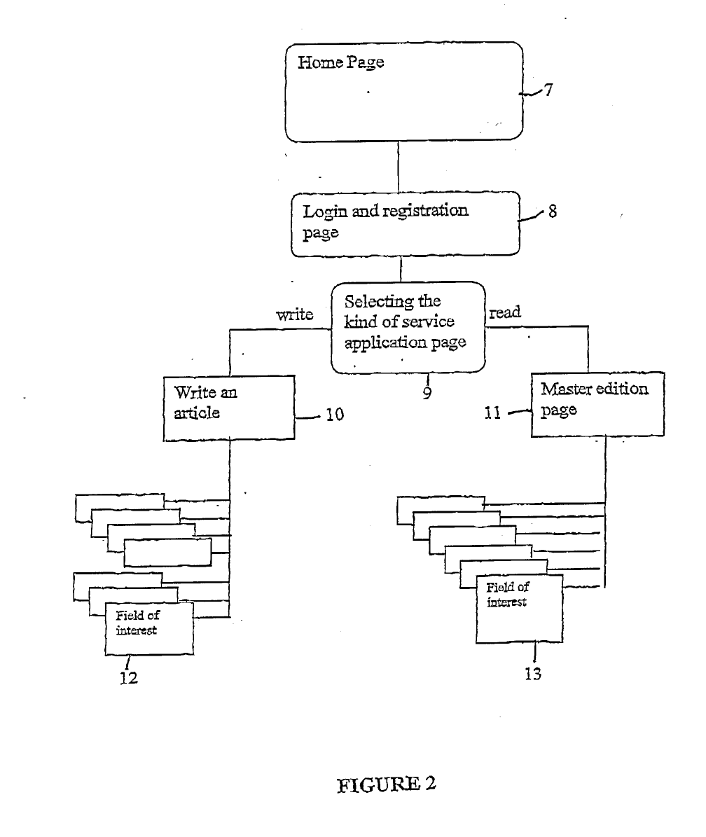

FIG. 2 illustrates the web pages diagram of the web site of the invention. A home page (7) is the first page as the user linked to the web site. Then the user is directed to Login and Registration page (8) for identifying. After that the user will be in the Selecting kind of service application page (9), to read newspaper from the Master edition page (11) and choosing the field of invention (13), or use the “write an article page” (10) and choose a field of invention (12) to write.

Plural user computers communicate with the network using standard web browsers such as Netscape Navigator and Internet Explorer browsers, the standard hypertext transfer protocol (HTTP) and hypertext markup language (HTML).

A user may utilize a computer to access system over the Web at a predetermined uniform resource locator BURL) As soon as the connection between browser and server is established, the user will find a self-explanatory “Home Page”, the internet term for the opening page on any web site. The user is directed through a series of steps to log on to the site and is offered the opportunity to ask any question, reply to questions asked by others, express opinions, comment on opinions of others, post emergency notices, and/or respond to emergency notices already posted. The proposed invention system is based on the premise that someone out there knows the answer to your question and that people will freely volunteer their “expertise” if asked.

The user may ask the question in plain language text. The user then directs the question to a particular field of interest. The user is taken through a series of steps to define the appropriate field of interest. For instance, if your question relates to baseball, you would see a general category of “leisure” then proceeds to “sports” and finally to “baseball”. It is designed to be very “user friendly”, and the path that the user follows is very logical and offers the feeling that the question is being treated seriously.

When a user enters the site and “registers” as a member (it is free of charge and follows an easy process in which confidentiality is completely preserved if the user so desires), the user is also asked to name his fields of interest. Then, when a question is asked in those fields of interest, the questions appear on that user own personal home page he may freely and voluntarily respond.

When a user enters the web site, he is asked on the home page if he wants to ask a question or express an opinion. If he chooses to express an opinion, he types in up to 1,000 words, give it a headline and then follows a similar process, as above, of directing the opinion to the appropriate field of interest.

Each field of interest (many fields have been pre-defined into the web site and other will be added automatically in accordance with definitions of the users) will “publish” on a daily basis a newspaper that gathers all the opinions expressed in that field of interest.

The most widely lead articles (the system automatically detects when a user reads an article) are then gathered in a daily master edition of the article newspaper. In a parallel manner to the question and answer feature, there can be responses to the articles. The responses in turn are treated as articles of their own and axe published in the same field of interest daily newspaper, and they axe also directed to the home page of the author of the original article piece.

1. A method for obtaining at least one dynamic internet web site newspaper comprising:
(a) selecting a suitable newspaper category that matches the subject of the article to be typed and inserted to the newspaper;
(b) gathering the typed articles by the users into the appropriate selected newspaper in a prearranged newspaper format; and
(c) automatically calculating the number of people reading each article page and according continuously upgrading the location of each article in the newspaper according to the number of hits to the article page.

2. A method according to claim 1 wherein the articles are deleted after a predetermined period of time.

3. A method according to claim 1 wherein a message, that has not been read for a duration of pre-determined period of time is deleted.

4. A method according to claim 1 further comprising the steps of:
(a) creating a category of general master not specified dynamic newspaper; and
(b) collecting the most widely read articles in all the specific dynamic newspapers and locating and rating them in the appropriate location at the general master edition;

5. A system for creating, transmitting, receiving and processing information for displaying a dynamic newspaper using the method as defined in any of the preceding claims comprising:
(a) a Web server computer that hosts the web site and its applications software and linked to the Internet Network and provides a gateways that enables browsers to access the Web-related applications;
(b) an application software, which is a computer software program for receiving and processing the classified articles and sorting them in the newspaper appropriate dynamic newspaper and further rating them according to the number of hits to the article page;
(d) a browser, computer program element, which is the user's window interface to the Web, providing the capability to view Web documents and access Web-based services and applications;

6. A dynamic Internet Web site newspaper characterized by continuos editing and upgrading the articles according to the number of hits to the article page;

7. A general master dynamic newspaper having the most widely read articles in a defined group of specific dynamic newspapers and rating the said articles in the appropriate location according to the number of hits in the specific dynamic newspaper.
